(19) United States
(12) Patent Application Publication
(10) Pub. No.: US 2002/0004774 A1
(43) Pub. Date: Jan. 10, 2002

(54) Data analysis system for tracking financial trader history and profiling trading behavior

(76) Inventor: Tony Defarlo, Glendale, NY (US)

Correspondence Address: Anthony J. Casella, CASELLA & HESPOS, 274 Madison Avenue - Suite 1703, New York, NY, 10016, US

(21) Appl. No.: 09/818,088

(22) Filed: Mar. 27, 2001

Related U.S. Application Data
(60) Provisional application No. 60/192,382, filed on Mar. 27, 2000.

(51) Int. Cl. G06G 1/12

(52) U.S. Cl. 705/36; 705/37

(57) ABSTRACT

An data analysis system is provided to allow traders of equities and other financial instruments to keep track of their trading history and to display a trade profile of their trading behavior. Trade results are analyzed by correlating trade transactions records with concurrent market conditions, categorizing the conditions, and appending condition data to the trade transaction record. The results are then displayed to the trader in the form of pivot tables and graphs. Users can access the data analysis system over a global information network, i.e. the Internet, or for a more secure environment, the data analysis system can also reside on a local area network (LAN) or intranet. In addition to collecting trade results for individual traders, data is aggregated based on the trader's organization so management of the firm can determine what strategies offer the best profitability or chance of success for most of the firm's traders.

This application claims the benefit of the filing date of Provisional Patent Application, U.S. Ser. No. 60/192,382 filed Mar. 27, 2000, the disclosure of which is incorporated herein by reference.

### BACKGROUND OF THE INVENTION

1. Field of the Invention

The present invention relates generally to methods and related apparatus for analyzing financial trading data, and more particularly, to a data analysis system to allow traders of equities and other financial instruments to keep track of their trading history and to display a trade profile of their trading behavior by correlating trade transactions records with concurrent market conditions, categorizing the conditions, and appending condition data to the trade transaction record.

2. Background of the Invention

Traders of financial instruments have a number of ways of making trading decisions. For some, these decisions are based on what are known as “fundamentals”—the company's earnings, cash flow, product development, growth rates etc. Other traders use “technicals”, which are basically mathematical descriptions of the stock price movements themselves. Both methodologies have advantages and disadvantages in analyzing stocks, bonds, indices, mutual funds, options and other securities, as disclosed in U.S. Pat. No. 6,012,042 to Black et al.

In technical analysis, security movements are predicted by examining past price movements. Technical data includes the price and volume figures for stocks, futures contracts, and related information. More particularly, technical data on price includes the open, high, low, and/or the close trading price of the day. Further price information could also include open, high, low and close prices on an hourly, weekly, monthly and yearly basis. Additionally, technical data such as the daily price at which the most shares were sold for a particular issue and similar data are also useful. Prior art data analysis systems using the “technical” method of trading perform hypothetical buying and selling decisions based on the price and volume history as well as various rules.

Fundamental analysis, used primarily for stocks, may be defined as any value-oriented corporate data used to help qualify and quantify an investor's expectations for a company's future, for example, annual company reports, SEC reporting requirements and publications. Fundamental data may also include earnings per share (EPS), a “quick ratio” for a general measure of how a company can cover its debts, dividends, net worth, price-to-earnings (PE) ratio, profit/loss statistics, etc. Whereas technical data is usually stored on a daily basis, fundamental data is less frequent, more irregular and requires more intuitive decision systems than those for technical systems using objective and ordered historical data.

A “third way” of making trading decisions is to combine fundamental, technical and personal historical trading behavior. This approach is based on the theory that each trader reacts differently to stock and market price movements. If the trader could see a quantatitive breakdown of his trading performance based on various market conditions, his personal strengths and weaknesses would be discernable. The trader would then base future trading decisions based on his past performance under similar conditions.

There are no products on the market today which do this. There are quote systems which provide information about current market conditions; charting programs to display the technical indicators of stock prices; screening programs which look for stocks which match certain fundamental and/or technical criteria; and “backtesting” programs which allow users to develop trading strategies and test them on historical data. No program takes the past performance of a trader and correlates it to various states and conditions which existed at the time of the trade.

It is an object of the present invention to provide a data analysis system which imports technical and fundamental financial data and correlates that data to the trading history of an individual trader.

It is a further object of the subject invention to provide a data analysis system which imports technical and fundamental financial data and correlates that data to the trading history of a trading firm to assist in implementing specific trading strategies.

Another object of the present invention is to provide a user-friendly interface through graphs, tables and spreadsheets which will allow the end-user, whether an individual or firm, to customize the analytical variables of the interface to optimize the output of the system.

It is another object of the present invention to provide access to the data analysis system through a local area network.

A further object of the present invention is to provide access to the data analysis system over a global information network.

It is a further object of the present invention to provide real-time updating of the technical and fundamental financial data.

A still further object of the subject invention is to provide a trading data analysis system with artificial intelligence to constantly monitor relationships and behavior to predict trading results.

### SUMMARY OF THE INVENTION

The above stated objects are met by a new and improved data analysis system to allow traders of equities and other financial instruments to keep track of their trading history and to display a trade profile of their trading behavior. Trade results are analyzed by correlating trade transactions records with concurrent market conditions, categorizing the conditions, and appending condition data to the trade transaction record. The results are then displayed to the trader in the form of pivot tables and graphs.

The new and improved trader data analysis system acquires transaction data from a trader's brokerage or clearing firm and records the information about the state of a financial instrument, the industry group which the financial instrument is part of, and the exchange the financial instrument is traded on. The transaction data is turned into trade records including the open positions of the trader. For each trading record, the data analysis system references external data necessary for analysis calculations, i.e. technical and fundamental data. The system then calculates the value of a number of technical indicators, sorts the results into categories and associates the results to the trade record. Trade specific information is then calculated, sorted into categories and associated to trade records. Lastly, the system calculates certain performance data of the trader, for example, various profit and loss (P&L) positions. After the analysis is finished, the system of the subject invention takes the trade records and restructures the data into a standard multidimensional database. This allows correlations of profit and loss, win ratio and a number of other measures to be made against factors such as momentum, volatility, sentiment, etc.

As the data analysis system builds up a trader's database, a profile of the trader's behavior under certain conditions will become apparent. By analyzing the resulting behavioral studies, a trader or trading firm will be able to determine what factors are typically present when a particular trader wins and what factors have typically led to losing trades.

For a simple example, Trader A likes to buy stocks which have fallen drastically in price that day in the hope the stock price will stop falling and move back up. Sometimes Trader A also buys stocks that are up sharply that day. When reconstructing Trader A's trades, the percentage price change from the previous day for the stock being traded is recorded, along with the result of the trade (the profit or loss, or “P&L”). By placing the trade results in a multidimensional database, the data analysis system can display the result of all trades made when the stock was down x% versus trades made when the stock was up y%. Trader A may now see that the strategy of buying stocks that were down sharply results in a loss 75% of the time, while buying stocks that were advancing in price that day resulted in winning trades 60% of the time.

In addition to collecting trade results for individual traders, data is aggregated based on the trader's organization, if he trades for a firm. Management of the firm can see the results based on different organizational levels within the company. This data can be used to determine what strategies offer the best profitability or chance of success for most of the firm's traders.

The multidimensional database of the subject invention is accessed through a user-friendly interface consisting of pivot tables and graphs. Users choose the variables they want to display and the resulting tables can overlay market performance indicators.

Users can access the data analysis system over a global information network, i.e. the Internet. The system is based on standard client-server architecture, where the client is installed on a trader's workstation and the database is located on a server attached to the Internet. For a more secure environment, the data analysis system can also reside on a local area network (LAN) or intranet eliminating the concerns of losing valuable information through an unsecure Internet.

Also by using a real-time price feed, traders can also check the historical probability of their trade. For example, the trader types in the symbol of the stock he is about to trade, and the data analysis system of the subject invention gets the current conditions of the market and looks to see if the current conditions of the stock, sector & market match any of the conditions already recorded. If there is a match, the probability of success will be displayed.

These and other features of the invention will be better understood through a study of the following detailed description and accompanying drawings.

### BRIEF DESCRIPTION OF THE DRAWINGS

FIG. 1 is a block diagram of the data analysis system of the subject invention.

FIG. 2 is a view of the display of the user interface of the subject invention for analyzing trading behavior.

FIG. 3 is a view of the information shown in FIG. 2 in table form.

FIG. 4 is a view of the display of the user interface of the subject invention for analyzing trading behavior in a TIME SERIES view.

FIG. 5 is a view of the display of the subject invention illustrating an OVERALL TRADE BREAKDOWN.

FIG. 6 is a view of the display of the subject invention illustrating a TIME OF ENTRY STUDY.

FIG. 7 is a view of the display of the subject invention illustrating a TRADE PERFORMANCE BREAKDOWN BY STOCK.

FIG. 8 is a view of the display of the subject invention illustrating a TRADE PERFORMANCE BREAKDOWN BY SECTOR.

FIG. 9 is a view of the display of the subject invention illustrating a DURATION STUDY.

FIG. 10 is a view of the display of the subject invention illustrating a MOVING AVERAGE STUDY.

FIG. 11 is a view of the information shown in FIG. 10 shown in a TIME SERIES view.

FIG. 12 is a view of the display of the subject invention illustrating trading performance data superimposed over a financial market index for the same time period.

FIG. 13 is a view of the information shown in FIG. 12 shown in 3-D format.

FIG. 14 is a view of the display of the subject invention illustrating a TRADER'S DAILY P&L RANGE.

FIG. 15 is a view of the display of the subject invention illustrating a TRADER'S PERFORMANCE BY TRADE employing user-defined criteria for sorting and ranking.

FIG. 16A is a view of the display of the subject invention illustrating a DAILY TRADE CHART accessed through the table of FIG. 15.

FIG. 16B is a view of the display of the subject invention illustrating an INTRADAY TRADE CHART accessed through the table of FIG. 15.

FIG. 17 is a view of the preferred embodiment of the data analysis system of the subject invention employing a global information network for user access.

FIG. 18 is a view of second embodiment of the data analysis system of the subject invention where the system is self-contained on a local area network or intranet restricting access to specific users.

### DETAILED DESCRIPTION OF THE INVENTION

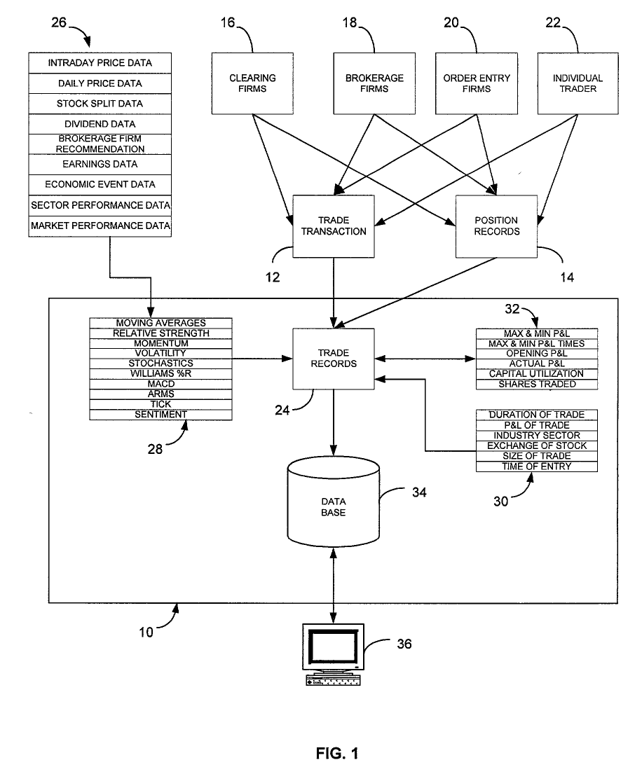

Referring to FIG. 1, the data analysis system for tracking trader history and profiling trading behavior of the present invention is generally indicated by the reference numeral 10. The data analysis system 10 comprises three processing steps to compile information for the multidimensional database. First, the system 10 acquires transaction data; second, the system 10 reconstructs the trades into trade records; and thirdly, applies analytical data to the trade records to compile the database for trader use.

For the purposes of the subject application, it is to be understood that a financial instrument can include, but not be limited to, stocks, bonds, options, futures and commodities. Additionally, it is to be understood that a trade is a set of transactions comprising buy transactions and sell transactions; for example, a simple trade would consist of a buy and a sell. The data analysis system classifies multiple transactions as a single trade until the position size of the trade goes to zero.

In the transaction acquisition phase, the data analysis system 10 takes as input data trade transaction 12 and position records 14. Those records can be supplied by any of the following : Clearing Firms 16, Brokerage Firms 18, Order Entry Firms 20, or Individual Traders 22. The transaction records 12, 14 are imported into the data analysis system 10 by direct connection with the transaction source computer system; communications link between source system and the data analysis system 10, either private or Internet; or manual input. Once the transaction records 12, 14 are uploaded, the data analysis system 10 translates the transaction records from the source format to a usable format of the data analysis system 10.

The transaction data is turned into “trade records” 24 by calculating the open positions of the trader, and then following each transaction to determine when a trade is completed and a new one initiated. When a new trade is calculated, a trade record is created which acts as a “label” to define which transactions belong to the trade.

Before the analysis of each trade record 24 begins, external market data 26, i.e. technical and fundamental, its retrieved from a securities information vendor. A plurality of outside sources of external market data 26 can be connected to the system. The following data is acquired daily and referenced during this process:

daily price data

stock split data

dividend data

brokerage firm recommendation data (upgrade/downgrade)

earnings data

economic event data

sector performance data

market performance data

Preferably early each evening, after the major United States markets have closed, the data 26 above is acquired from various data sources and integrated into the system 10 through appropriate interchange architecture. Data 26 received from external securities information vendors will involve one-way communications.

The data analysis system 10 then goes through each trade record 24 created and analyzes the trade record 24 with the external market data 26. The analysis routines check to see if the stock was upgraded or downgraded that day, the stock had earnings that day, the stock split that day, there was an economic news event that day, or if the stock formed one of the major “Japanese Candlestick Patterns”. If any of the above are true, it is noted on the trade record 24.

The data analysis system 10 then goes through each newly created trade record 24 and calculates the value of a number of “technical indicators” 28 at the time the trade was entered. Some of the technical indicators calculated are:

Moving Averages

Relative Strength

Momentum

Volatility

Stochastics

Williams % R

MACD

ARMS

Tick

Sentiment

The calculated results are then placed into categories and the value of the category is appended to the trade record 24.

The system 10 then calculates certain trade statistics 30 that are available from the data contained in the trade record 24 and the results are placed in categories and appended to the trade record 24. These statistics 30 are then used to assemble various studies. Examples of the various studies are listed below:

Duration of Trade

P&L of Trade

Industry Sector the stock is in

Exchange the stock trades on

Size of the trade

Time of entry into the trade

The data analysis system 10 then calculates what the open positions of the trader were for the date being studied and recreates the fluctuations in the trader's profit & loss in user-defined intervals, i.e. 5 minutes. Certain data about the trader's performance 32 is captured during this simulation and recorded in a multidimensional database 34. This trader performance data includes maximum and minimum P&L (profit and loss), maximum and minimum P&L times, P&L at the opening of the market, actual P&L, capital utilization and shares traded.

After all analysis is finished, the data analysis system 10 takes the trade records and restructures the data into a standard multidimensional database 34. This allows correlations of profit & loss, win ratio and a number of other measures to be made against any of the factors listed above. As the system 10 builds a trade database 10 over time, a profile of trading behavior for each user will be created. Users, i.e. individual traders or management of trading firms, will be able to see what factors are typically present when traders win and what factors have led to losing trades.

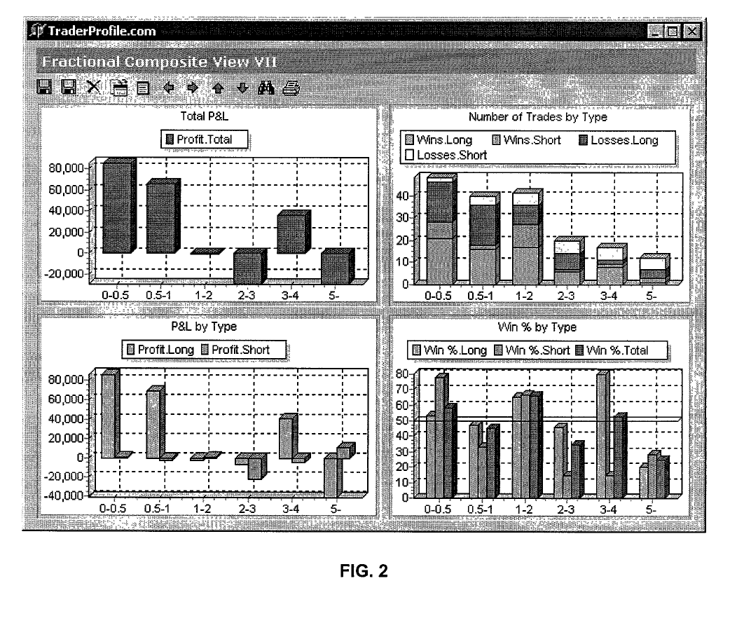

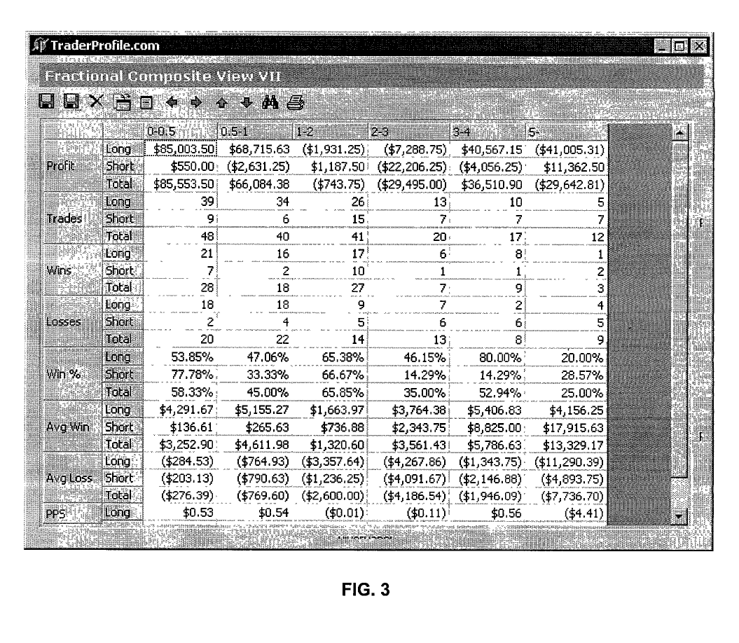

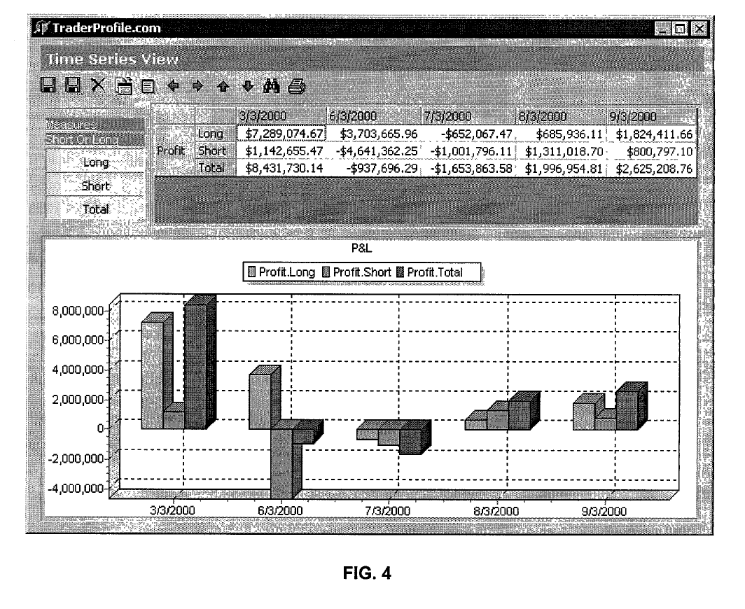

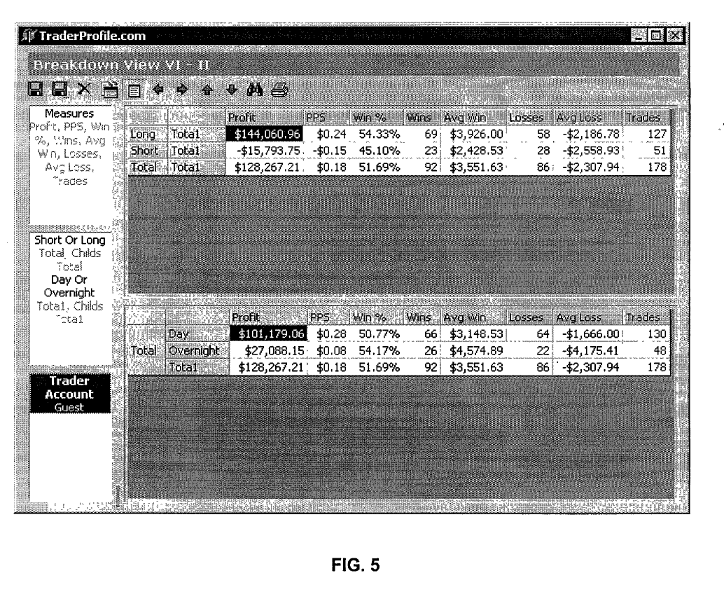

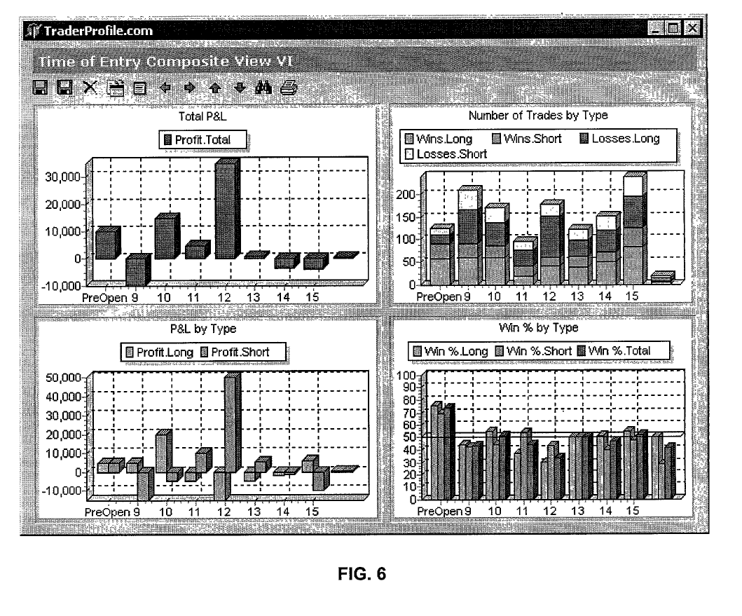

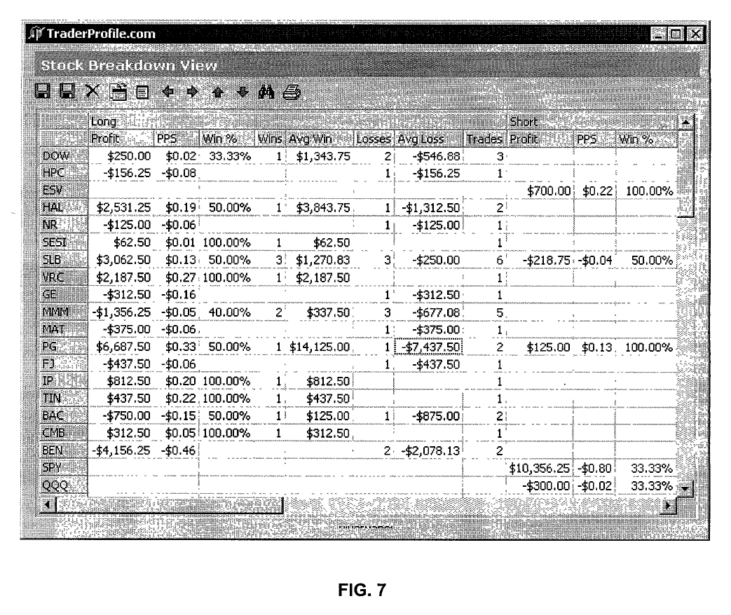

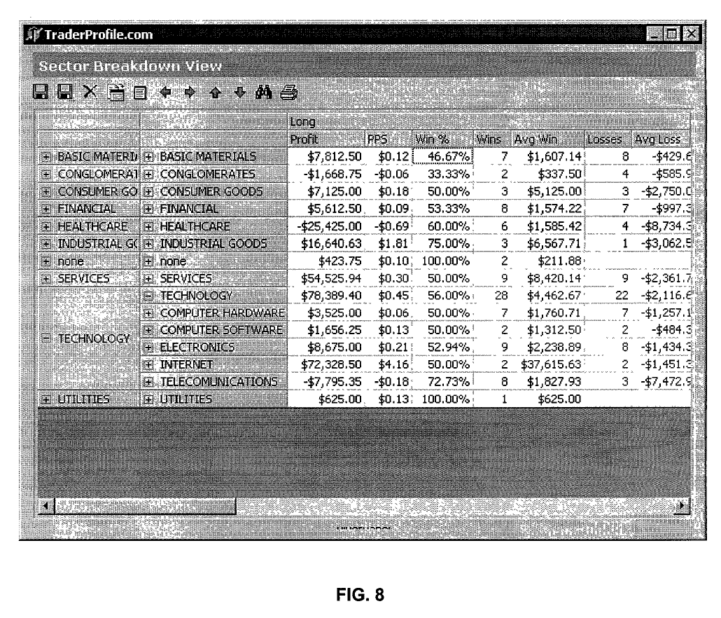

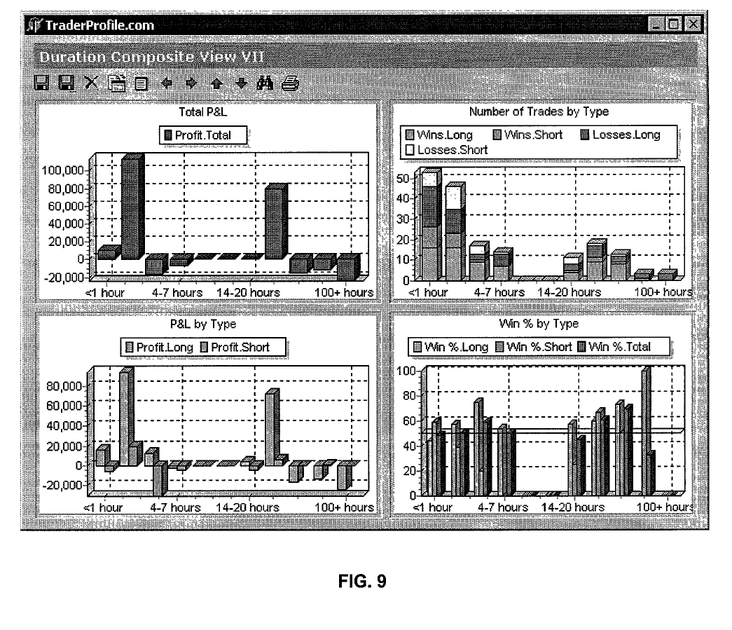

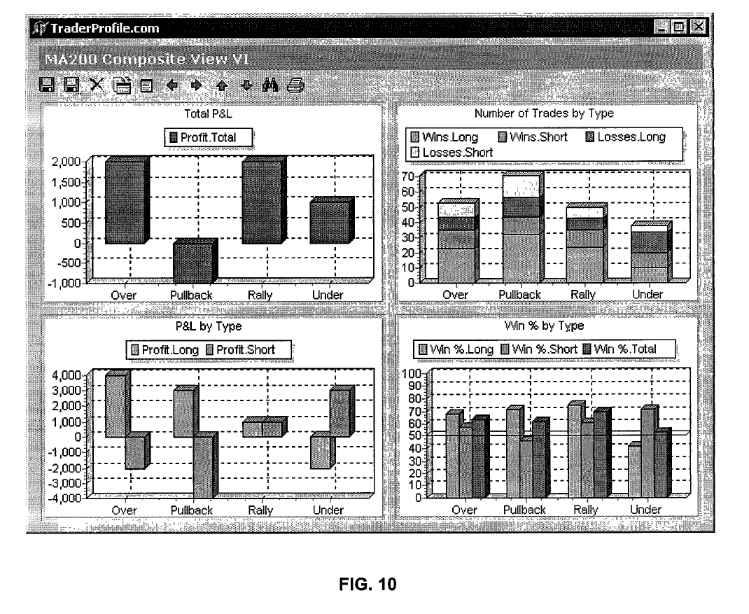

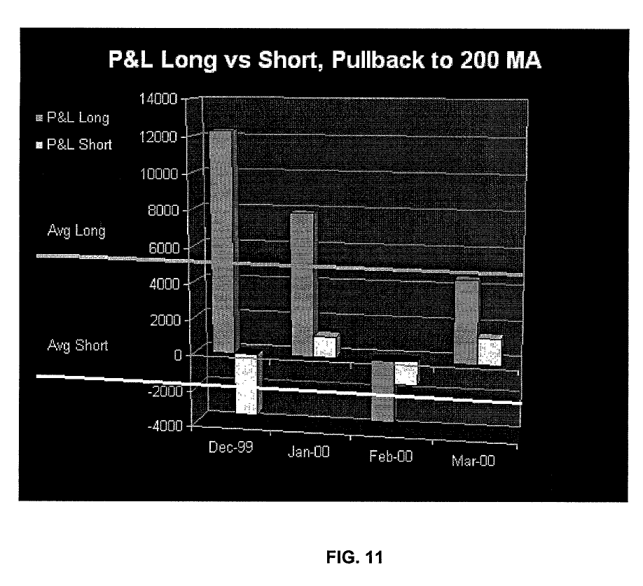

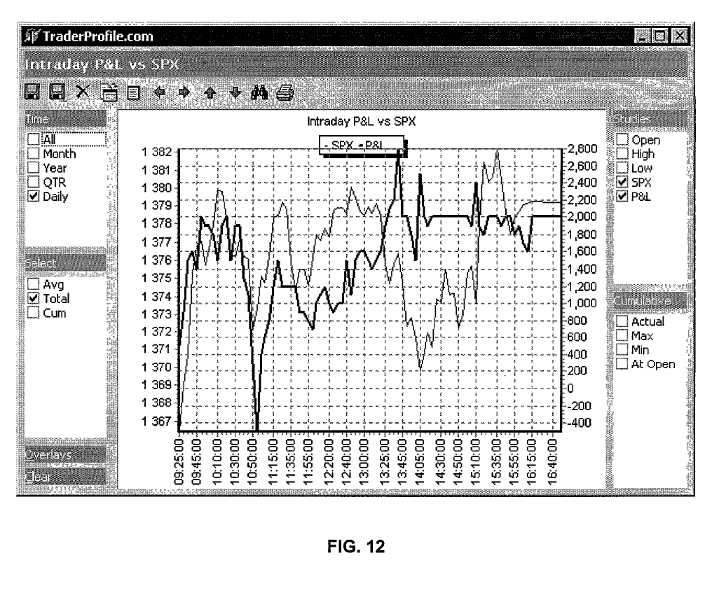

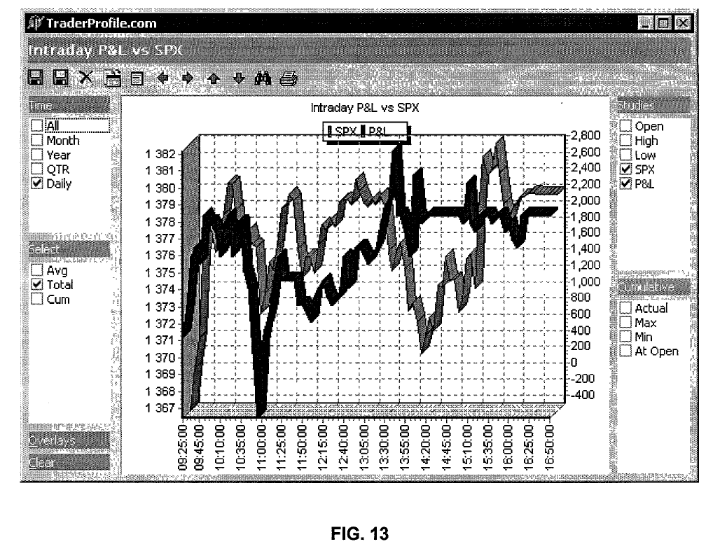

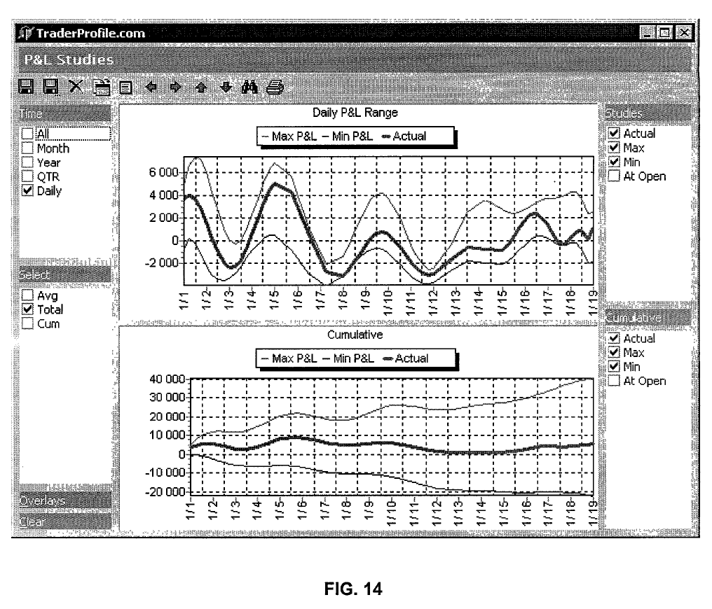

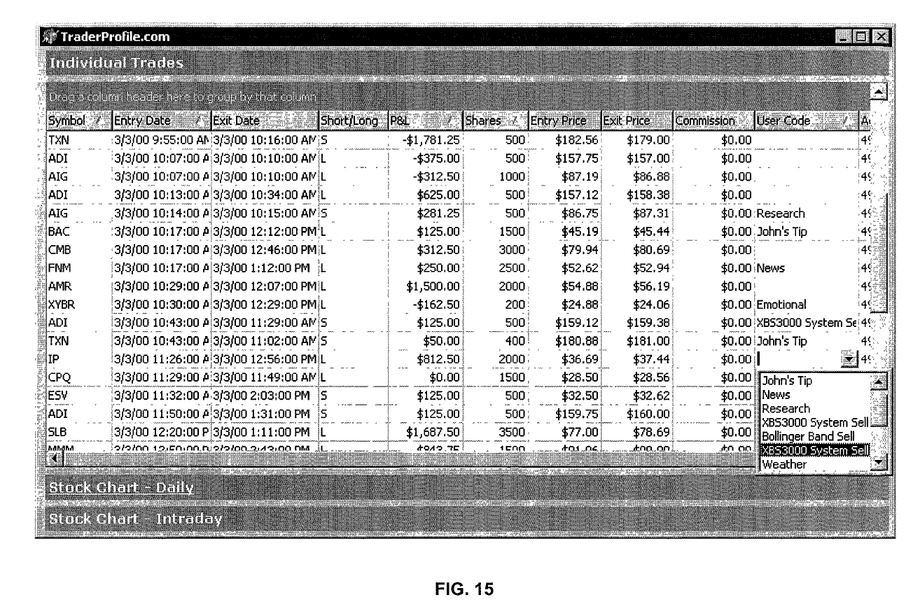

The multidimensional database 34 is available to each user through a user-friendly interface 36 on standard computing platforms. Users choose the variables they want to display and data is displayed through a custom application consisting of pivot tables and graphs. Referring to FIGS. 2 through 16, various displays of the information contained in the database 34 are shown in varying formats, i.e. charts, graphs, tables and 3-D charts. The following table lists some of the studies available through the interface 36 and the analytical results they provide:

| | |
|---|---|
| Overall Trade Breakdown | Shows trades broken down into long, short |
| | overnight and day trades. |
| Time of Entry Study | Shows the relationship between trades and |
| | time entered. |
| Stock & Sector Studies | Trading performance broken down into each |
| | stock and sector. |
| Duration Study | Results categorized by length of time trader |
| | was in the trade. |
| Moving Average Study | Shows trade results based the position of the |
| | stock relative to the 200, 50 or 10 day |
| | moving average. |
| Share Size Study | Results categorized by the share size traded. |
| Exchange Study | Trading results broken down by exchange, |
| | such NYSE stocks vs. NASDAQ. |
| Fractional Result Study | A matrix which shows the number and |
| | fractional gain/loss of winners and losers. |
| Day Of Week Study | Trade results broken down the by the day of |
| | the week trade was entered. |
| Stochastic Study | Shows trades based on stochastic reading at |
| | the time of the trade. Measures long and |
| | short performance when a stock is in an |
| | overbought or oversold condition. |
| Momentum Study | Trade results broken down by momentum |
| | value. |
| Range Study | Trade results by where the entry point was |
| | relative to the range of stock at the time of |
| | entry. |
| Net Change Stock Study | Trade results by the percentage net change of |
| | the stock. |
| Net Change Sector Study | Trade results by the percentage net change of |
| | the sector. |
| Net Change Market Study | Trade results by the percentage net change of |
| | the market. |
| Net Change Combo Study | The net change of the stock, sector and |
| | market are calculated together. For example, |
| | show long vs. short results when market is |
| | strong, sector is weak and the stock is strong. |
| Relative Strength Study | Trade results based on how far from a 52 |
| | week high or low the stock was at the time |
| | of entry. |
| Volatility Study | Trade results based on the volatility reading |
| | of the stock. |
| Bollinger Band Study | Shows trade results for stocks which were at |
| | upper or lower Bollinger Bands. |
| MACD Study | Shows results when MACD indicators gave a |
| | buy or sell signal. |
| Candlestick Study | Shows results based on trades where the |
| | stock formed one of the major candlestick |
| | patterns. |
| Earning Study | Shows performance when a trade was |
| | entered immediately before or after earnings |
| | where announced; performance based on |
| | earnings being above or below consensus. |
| Upgrade/downgrade Study | Shows performance when a trade was |
| | entered immediately after the stock was |
| | upgraded or downgraded. |
| Split Study | Shows performance when a trade was |
| | entered immediately before or after the stock |
| | split. |
| Economic News Study | Shows performance when a trade was |
| | entered on a day where economic news was |
| | announced; performance based on the news |
| | being above or below consensus. |
| What if Study | Shows how trader results would have |
| | changed had trader held on for one, two or |
| | five more days. |
| Intraday P&L Chart | A chart of trader's daily P&L in 5 minute |
| | increments with the movements of the SPX- |
| | superimposed. |
| Daily P&L Range | This chart shows a weekly graph of a |
| | trader's P&L with the high, low and actual |
| | P&L each day. It shows how much profit |
| | was “left on the table”, and how well |
| | the trader has recovered from the lows of |
| | the day in their P&L. |
| At Open P&L | Shows P&L for overnight positions at the |
| | open. A good way to judge overnight |
| | trading. Shows the difference between what |
| | trader actually did and what the result would |
| | have been had trader held them until the |
| | close, and the result if trader had exited |
| | all of them at the open. |
| Minimum/Maximum P&L | Shows the median time of day P&L is |
| Times | normally at it's high and low points. |
| Position Study | Shows how the number of open positions |
| | during the trading day relates to P&L. |
| Capital Utilization Study | Shows trading results based on day and |
| | overnight capital utilization. |
| Holding Losers | When a trader sells a position at a loss, the |
| | system records if it would have been |
| | profitable by the end of day. |
| User Defined Study | Users can code their own trades, describe |
| | why they entered them and see results based |
| | on those codes. |
| Average Up/Down Study | The results of trades where you averaged |
| | up or down. |
| Tick Study | Trade results broken down by the tick |
| | reading. |
| ARMS Study | Trade results broken down by the ARMS |
| | reading. |
| Sentiment Study | Trade results based on market sentiment. |

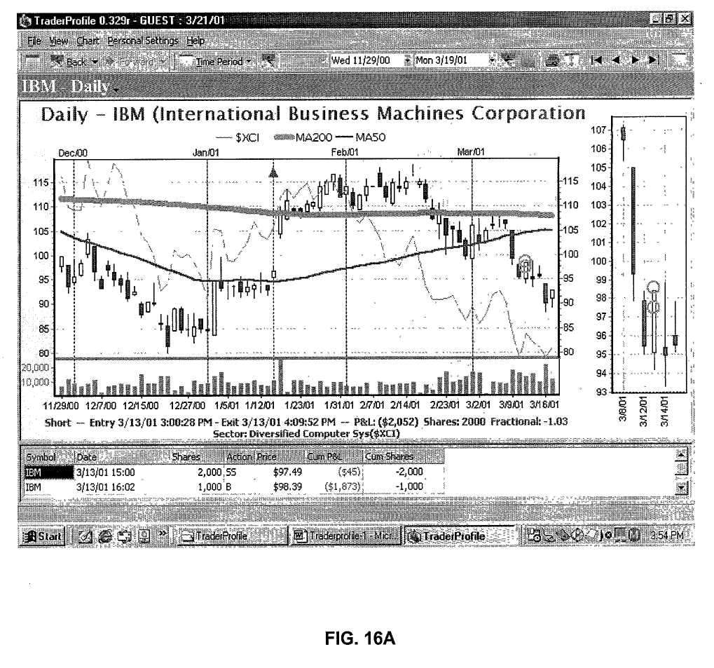

Some of the more relevant studies are the daily and intraday trade charts, as shown in FIGS. 16A and 16B. The purpose of trade charts is to allow a trader, or manager of traders, to review specific trades. By plotting transaction data over daily and intraday price data of stock, sector and market movements, the trader and or manager sees what the trader, the stock and the sector or market were doing during the trade. This allows for analysis and critique of the trader's actions, as well as greater insight into the effect of different price patterns on the trade. Additionally, the number of shares held and the profit or loss fluctuations are drawn on the chart as well, which shows how the trader varied his position size relative to his profitability during the trade.

FIG. 16A shows the layout of the Daily Trade Charts. The main graph 200 shows the daily chart and the graph 202 on the right of the screen is magnified view of the days surrounding a particular trade. The small bar graph 204 at the bottom of the main chart normally shows the volume of the stock, although can be changed to plot various technical indicators. Underneath the volume sub-graph 204, there is descriptive text 206 about the trade—whether it was long or short, entry and exit dates and times, the P&L, number of shares traded, fractional gain or loss, the sector the stock is classified in, and if applicable, the tradable index of the industry group. On the daily charts 200, the circles 208 represents the average price of the buy or sell transactions (on intra-day charts each transaction is shown, not just the average entry and exit prices), and the circles 210 indicate the price of the sell or sell short transactions. Underneath the trade chart 200 is a table 212 that shows all transactions in the trade.

Reviewing trades on the daily chart is good for looking at the overall situation in the stock. Normally, trading behavior is best seen by looking at the intra-day charts as shown in FIG. 16B. While looking at the intra-day trade chart, a trader can view a trade as compared to a volume sub-graph or a P&L shares sub-graph 302. The intraday chart can show a trader their share size at each point in the trade and their P&L, easily seeing how their P&L fluctuated throughout the trade. Instead of plotting shares and P&L, the intraday chart can also plot certain technical indicators.

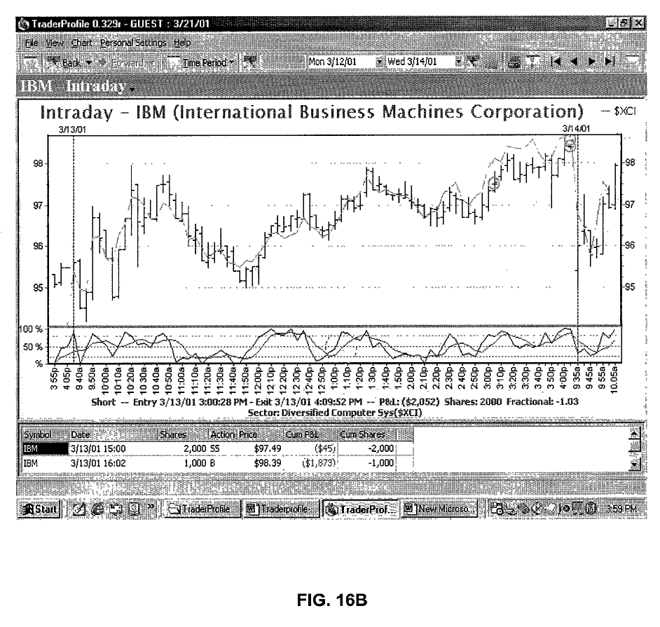

In a preferred embodiment, the data analysis system 10 will perform on a standard client-server architecture over the Internet 38, as shown in FIG. 17. Users will access the system 10, as a client, from any standard computer platform 36 through an Internet connection 40. The Internet connection 40 can be any method known in the art, for example, modem, ISDN, DSL, etc.

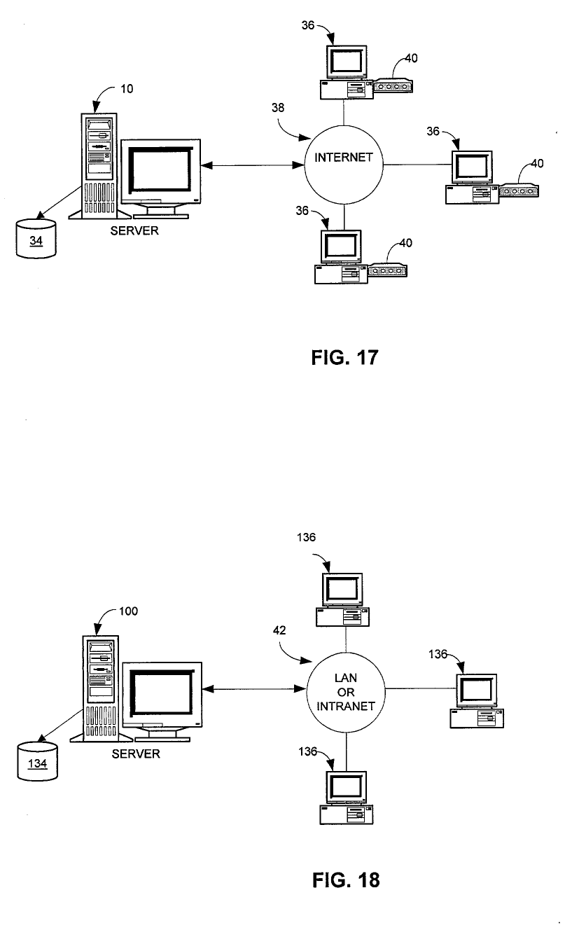

In another embodiment where a more secure environment is required, the data analysis system 10 can also reside on a local area network (LAN) or an intranet 42 as shown in FIG. 18. The system 10 will reside on the local server 100 and users will access the system 10 through individual workstations 136.

In another embodiment, the data analysis system 10 not only records trading performance for individual traders, but performance for trading firms as well. Results can be seen by desk, office or the company as a whole. Displays can be configured from the database 34 to allow firm management to develop better proprietary trading strategies. If a firm sees a set of conditions which usually lead to profitable trades, decision systems can be developed that execute trades when those conditions are present. On the converse side, the system 10 can also help risk management by tracking conditions that normally lead to losses allowing risk managers to hedge the firm's positions or instruct traders to reduce size or activity during those conditions.

In a further embodiment, the data analysis system 10 will be integrated with real-time data. Before making a trade, a trader can type in the symbol of the stock he or she is about to execute and the historical probabilities of success under similar conditions will be displayed.

In a further embodiment, the data analysis system 10 will also incorporate artificial intelligence. The system 10 will look for consistent relationships over time and present the trader or trading firm with the results. For example, the program would report to Trader A that it has found shorting stocks that are up strongly on a day when the PPI is better than expected as led to losses 80% of the time.

What is claimed is:

1. A method for tracking trader history and profiling trading behavior, said method comprising the steps of:
acquiring transaction data relating to a financial instrument;
converting said transaction data into a trade record;
acquiring external market data relating to said financial instrument; and correlating said external market data to said trade record.

2. The method as in claim 1, wherein said transaction data comprises buy transactions and sell transactions of said financial instrument.

3. The method as in claim 1, wherein said step of converting said transaction data to said trade record further comprises calculating a open position of a trader and determining when said position becomes zero.

4. The method as in claim 1, wherein said external market data comprises fundamental data and technical data.

5. The method as in claim 1, wherein said step of correlating said external market data to said trade record further comprises the steps of
calculating a first value for a plurality of technical indicators, said first value of technical indicators being determined at a time of a transaction;
sorting said first values of technical indicators into categories; and
appending said first value of said category of technical indicators to said trade record.

6. The method as in claim 1, wherein said step of correlating said external market data to said trade record further comprises the steps of
calculating a second value for a plurality of trade statistics, said second value of trade measures being determined at a time of a transaction;
sorting said second values of trade statistics into categories; and
appending said second value of said category of trade measures to said trade record.

7. The method of claim 1, wherein said step of correlating said external market data to said trade record further comprises the steps of
calculating a open position of a trader;
recreating fluctuations in said trader's profit and loss in predetermined time intervals beginning at a time of said open position to simulate said trader's performance; and
storing said trader's performance data in a multidimensional database whereby said data can be viewed in various formats to allow said trader to analyze said trader's trading performance against various financial market valuables.

8. The method of claim 1, wherein said step of correlating said external market data to said trade record further comprises the steps of
calculating open positions of a plurality of traders of a financial brokerage firm;
recreating fluctuations in said traders' profit and loss in predetermined time intervals beginning at a time of said open positions to simulate said traders' performance; and
storing said traders' performance data in a multidimensional database whereby said data can be viewed in various formats to allow said financial brokerage firm to analyze said traders' trading performance against various financial market valuables to determine said financial brokerage firm's trading strategy.

9. The method as in claim 1, wherein said step of acquiring said external market data executes once a day after a financial market stops trading.

10. The method as in claim 1, wherein said step of acquiring said external market data executes continuously in real time.

11. The method as in claim 1, further comprising the step of monitoring said correlation of said external market data to said trade record to determine consistent relationships of trading success.

12. A data analysis system for tracking trader history and profiling trading behavior, said data analysis system comprising:
a first input means for acquiring transaction data relating to a financial instrument;
a means for converting said transaction data into a trade record;
a second input means for acquiring external market data relating to said financial instrument; and
a processing means for correlating said external market data to said trade record.

13. A data analysis system as in claim 12, further comprising a storage means for storing said correlated data.

14. A data analysis system as in claim 12, further comprising a display means for displaying said correlated data in the form of graphs and tables.

15. A data analysis system as in claim 14, wherein said display means being a computer terminal.

16. A data analysis system as in claim 12, wherein said transaction data comprises buy transactions and sell transactions.

17. A data analysis system as in claim 12, wherein said external market data comprises fundamental data and technical data.

18. A data analysis system as in claim 12, wherein said first input means being a direct connection with a transaction source computer system.

19. A data analysis system as in claim 12, wherein said first input means being a manual input.

20. A data analysis system as in claim 12, wherein said second input means being a direct connection to an external securities information vendor, said direct connection being a one-way communication link.

21. A data analysis system as in claim 12, wherein said second input means being a real-time external market data feed.

22. A data analysis system as in claim 12, further comprising an artificial intelligence means for monitoring said correlation of said external market data to said trade record to determine consistent relationships of trading success.

23. A data analysis system as in claim 12, wherein said first input means, said converting means, said second input means and said processor means reside on an implementing server.

24. A data analysis system as in claim 23, wherein said implementing server being connected to a global information system.

25. A data analysis system as in claim 23, wherein said implementing server being connected to a local area network.

26. A data analysis system as in claim 23, wherein said implementing server being connected to an intranet.
